(19) United States
(12) Patent Application Publication
(10) Pub. No.: US 2024/0393442 A1
(43) Pub. Date: Nov. 28, 2024

(54) Liquid-Mounted Optical Sensor Apparatus for a Motor Vehicle

(71) Applicant: Bayerische Motoren Werke Aktiengesellschaft, Muenchen (DE)

(72) Inventor: Tobias BIALETZKI, Pleinfeld (DE)

(21) Appl. No.: 18/689,458

(22) PCT Filed: Jun. 22, 2023
(86) PCT No.: PCT/EP2023/066899

§ 371 Date: Mar. 6, 2024

(30) Foreign Application Priority Data
Jul. 11, 2022 (DE) 10 2022 117 219.8

(51) Int. Cl. G01S 7/497; G01S 7/481; G01S 17/86; G01S 17/931

(52) U.S. Cl. CPC G01S 7/497; G01S 7/4813; G01S 17/86; G01S 17/931; G01S 2007/4977

(57) ABSTRACT

An optical sensor apparatus for a motor vehicle has an optical lens arranged at a lens housing, a cover configured to cover at least the optical lens, a bearing configured to mount the cover, a drive which is configured to move at least the cover relative to the lens, and a cleaning agent configured to wet the cover. The bearing has a fluid bearing that is fed with the cleaning agent.

### BACKGROUND AND SUMMARY

The present invention relates to an optical sensor apparatus for a motor vehicle, a camera apparatus equipped therewith, a radar apparatus equipped therewith, and a motor vehicle equipped therewith.

More and more optical sensor apparatuses which are used in particular in camera systems or radar systems are being installed in motor vehicles. Since the optical sensors present therein are sometimes exposed to quite harsh environmental conditions, there is a desire to be able to clean them by means of suitable apparatuses. For example, DE 10 2013 006 686 A1, DE 10 2018 006 529 A1, DE 10 2018 116 822 A1, DE 10 2020 107 394 A1 and DE 10 2021 004 644 A1 all disclose sensors which are located in a rotary housing and are cleaned upon a suitable movement via an assigned scraper and/or by being wetted with a cleaning agent. The movement itself is carried out in each case via an electromotive drive apparatus, wherein the mounting of the respective housing in the sensors known from the prior art is disadvantageously either not shown in detail or is comparatively complicated. Further corresponding apparatuses are known from DE 10 2014 004 172 A1, DE 10 2017 111 759 A1, DE 10 2017 130 028 A1, DE 10 2017 221 494 A1, DE 10 2018 118 729 A1, DE 10 2020 210 422 A1, DE 11 2018 001 568 T5, DE 19 07 202 A, DE 20 20 436 A, DE 21 35 297 A, DE 21 19 868 A, US 2014/0 036132 A1, US 2019/0 329 737 A1 and JP 2015-182 656 A.

It is therefore the object of the present invention to overcome the aforementioned disadvantages.

This object is achieved by the features of the independent claims. The dependent claims relate to advantageous refinements.

The optical sensor apparatus according to the invention for a motor vehicle has an optical lens (which may also be in the form of a lens stack) that is arranged at a lens housing and is covered by a cover. The lens is, as is known per se, operatively connected to an electronic system, which in turn is operatively connected in particular to an electronic system, which is known per se, of a camera apparatus and/or an on-board electronic system of a motor vehicle. It should be noted that the sensor apparatus can detect light from the spectrum perceptible to a human eye and/or light from the spectrum that is not perceptible to a human eye. For this purpose, the cover is optically transmissive, so that radiation emitted or received by the sensor can be detected by a sensor located in the sensor apparatus. The cover itself is mounted by a bearing device and is movable relative to the lens by way of a drive. For the purpose of cleaning the cover, a cleaning agent is provided, which wets the cover in the form of a cleaning liquid.

The optical sensor apparatus according to the invention is characterized in that the bearing device has a fluid bearing that is fed with the cleaning agent. This advantageously enables a simple and at the same time reliable, easy-to-accomplish movement of the cover with a good cleaning quality at the same time.

The frequency of the cleaning and/or the dwell time of the section to be cleaned can be selected depending on the application, in particular according to the type and/or severity of the contamination of the section of the cover located in front of the lens. In particular, it is possible to carry out the cleaning cyclically or continuously.

Overall, it is possible with the optical sensor apparatus according to the invention to advantageously achieve a high cleaning efficiency, which obviates the need to carry large amounts of cleaning agents and provide large installation space, in particular in a suitably equipped camera system, radar system or motor vehicle.

According to the principle, a desired movement of the cover can take place via a drive known per se from the prior art, in particular an electromotive drive. According to a preferred embodiment of the present invention, however, the drive is formed as a fluid flow formed by the cleaning agent. In other words, the cover is not only mounted by means of the fluid bearing, but also moved by a controlled flow of the cleaning agent located in the fluid bearing.

A particularly simple and compact construction of the optical sensor apparatus according to the invention is advantageously achieved in that the bearing device is in the form of a bearing which is located between the cover and a sheath at least partially surrounding the former with the formation of a gap, and in which a cleaning agent is located.

According to a preferred embodiment, the sheath has at its ends close to the cover at least one sealant in each case. Thereby, the reliable working method of the optical sensor apparatus according to the invention is advantageously further increased.

Cumulatively, the sealant can advantageously have a scraper. This will further improve the cleaning of the cover.

The object described above is also achieved by a camera apparatus which has at least one optical sensor apparatus of the type previously disclosed. The advantages outlined above correspondingly apply.

The object described above is also achieved by a radar apparatus which has at least one optical sensor apparatus of the type previously disclosed. The advantages outlined above correspondingly apply.

The object described above is finally also achieved by a motor vehicle having at least one optical sensor apparatus of the type previously disclosed and/or a camera apparatus of the type previously disclosed and/or a radar apparatus of the type previously disclosed. The advantages outlined above correspondingly apply.

The appended figures, which are not to scale, will be referred to below to describe exemplary embodiments of the present invention in a detailed, non-prejudicial, in particular non-limiting, manner.

### BRIEF DESCRIPTION OF THE DRAWINGS

FIG. 1 is a simplified side view in section through an optical sensor apparatus according to an embodiment of the invention, which is part of a camera apparatus located at a symbolically illustrated motor vehicle.

FIG. 2 shows an alternative embodiment to the embodiment shown in FIG. 1.

### DETAILED DESCRIPTION OF THE DRAWINGS

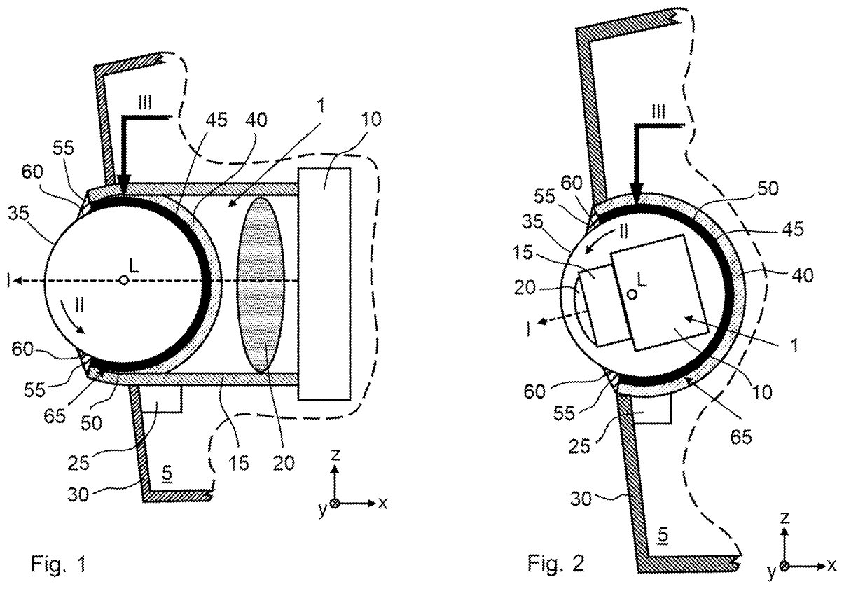

FIG. 1 represents a section through an optical sensor apparatus 1, which is part of a camera apparatus 10 located at a symbolically illustrated motor vehicle 5.

The optical sensor apparatus 1 has an optical lens 20 that is located in a lens housing 15 and is fastened by means of a holder 25, which is operatively connected to the lens housing 15, at an appropriate location of the motor vehicle 5, here a front-side section of the vehicle body 30. The viewing direction of the lens 20 is aligned from right to left in accordance with the mode of illustration selected here in the figure, as is symbolized by the arrow I.

The lens housing 15 is provided with a cover 35 on the outside for the protection of the lens 20, which cover is designed according to the present exemplary embodiment as an optically transmissive cylinder (see also arrow I). The cover 35 is rotatably mounted in a half-shell-shaped bearing 40 positioned in the lens housing 15, as is symbolized by the arrow II. For this purpose, a gap 45 is located between the corresponding surfaces of the cover 35 and the bearing 40 formed as a sheath, which gap is filled with a cleaning agent 50 equal to a fluid bearing. The gap 45 is sealed on the outside of the body with a sealant 55. The sealant 55 itself additionally has a scraper 60, which contacts the surface of the cover 35.

The cleaning agent 50 consists of a liquid and is conveyed from a tank (not shown here) via a line into the gap 45, as is symbolized by the arrow III. The cleaning agent 50 is conveyed in such a way that not only a corresponding liquid film is formed in the gap 45; rather, the cover 35 is made to rotate by the flow of the cleaning agent 50. As a result, the corresponding fluid flow acts as a drive 65, without requiring a further drive device known from the prior art, such as an electric motor.

The cleaning procedure of the cover 35 is carried out in such a way that the latter is moved continuously or non-continuously by the aforementioned drive 65 about the longitudinal axis L in a direction of rotation (see arrow II). The movement can be initiated, accelerated, decelerated or stopped, for example, depending on time, location data or depending on a user of the apparatus according to the invention.

As shown in FIG. 1, the cover 35 forms an inherent part of the lens housing 15. However, this does not necessarily have to be the case, as can be seen from the exemplary embodiment shown in FIG. 2: Here, the camera apparatus 10 is located completely within the cover 35, wherein, according to the principle, the basic construction and the basic functioning of the cover 35 shown in FIG. 1, of the bearing 40, of the gap 45, of the cleaning agent 50, of the sealant 55, of the scraper 60 and of the drive 65 are retained. In this respect, reference is made to the exemplary embodiment shown in FIG. 1. Thus, the cover 35 is cleaned in a cleaning process by the cleaning agent 50 present in the form of a liquid and moved around the camera apparatus 10 in its entirety.

It should be noted that the optical sensor apparatus 1 of a motor vehicle 5 shown in the figure can also be provided in a radar apparatus (not shown here) designed as a LIDAR apparatus.

It should further be noted that the optical sensor apparatuses 1 shown in FIG. 1 and/or FIG. 2 may also have a collecting apparatus (not shown here) for dripping cleaning agent 50 in order to recycle the correspondingly returned washing water and be able to use it again for the purpose of cleaning the covering means 35.

### LIST OF REFERENCE SIGNS

1 Optical sensor apparatus
5 Motor vehicle
10 Camera apparatus
15 Lens housing
20 Optical lens
25 Holder
30 Vehicle body
35 Cover
40 Bearing
45 Gap
50 Cleaning agent
55 Sealant
60 Scraper
65 Drive
I Visual axis
II Direction of rotation
III Line
L Longitudinal axis
x, y, z Coordinates of a Cartesian coordinate system according to ISO 4130-1978

1.-8. (canceled)

9. An optical sensor apparatus for a motor vehicle, comprising:
an optical lens arranged at a lens housing;
a cover configured to cover at least the optical lens;
a bearing configured to mount the cover;
a drive which is configured to move at least the cover relative to the lens; and
a cleaning agent configured to wet the cover,
wherein
the bearing is a fluid bearing that is fed with the cleaning agent.

10. The optical sensor apparatus according to claim 9, wherein
the drive is formed as a fluid flow formed by the cleaning agent.

11. The optical sensor apparatus according to claim 9, wherein
the bearing is located between the cover and a sheath at least partially surrounding the bearing while forming a gap in which cleaning agent is located.

12. The optical sensor apparatus according to claim 11, wherein
the sheath, at ends thereof close to the cover, has at least one sealant in each case.

13. The optical sensor apparatus according to claim 12, wherein the sealant has a scraper.

14. An apparatus, comprising:
a camera; and
at least one optical sensor apparatus according to claim 9.

15. An apparatus, comprising:
a radar device; and
at least one optical sensor apparatus according to claim 9.

16. A motor vehicle, comprising:
at least one optical sensor apparatus according to claim 9; and
at least one of a camera or a radar device.
